(19) United States
(12) Patent Application Publication
(10) Pub. No.: US 2026/0133555 A1
(43) Pub. Date: May 14, 2026

(54) MOVEMENT TARGET SPECIFICATION SYSTEM, MOVEMENT TARGET SPECIFICATION APPARATUS, TARGET SPECIFICATION METHOD, AND COMPUTER READABLE MEDIUM

(71) Applicant: NEC Corporation, Minato-ku, Tokyo (JP)

(72) Inventor: Natsuki KAI, Tokyo (JP)

(73) Assignee: NEC Corporation, Minato-ku, Tokyo (JP)

(21) Appl. No.: 19/119,862

(22) PCT Filed: Nov. 17, 2022
(86) PCT No.: PCT/JP2022/042725

§ 371 Date: Apr. 10, 2025

(51) Int. Cl. G05B 19/27

(52) U.S. Cl. CPC G05B 19/27; G05B 2219/50206

(57) ABSTRACT

It is possible to provide a movement target specification system including: a holding unit that holds a movement target; a height acquisition unit that acquires a height of an image capturing apparatus; a recognition unit that recognizes positions of corners present on a front surface of the movement target; a search unit that searches for similar data similar to the image of the movement target in accordance with the acquired height of the image capturing apparatus and the recognized positions of the corners present on the front surface of the movement target; an estimation unit that estimates positions of corners present on a rear surface of the movement target; and a target specification unit that specifies a state of the movement target.

### TECHNICAL FIELD

The present disclosure relates to a movement target specification system, a movement target specification apparatus, a target specification method, and a computer readable medium.

### BACKGROUND ART

In a system in which a mobile body conveys a pallet, a technology for determining a position and a posture of the pallet is used. Patent Literature 1 discloses that a position and a posture of a pallet can be estimated based on a line segment of a bounding box (hereinafter referred to as a BB) surrounding the front surface or one of two holes of the pallet in an image of the pallet captured by a camera. Further, Patent Literature 1 discloses that a position and a posture of the pallet may be estimated in accordance with BB data and reference data.

Patent Literature 2 discloses a method for determining whether or not a forklift is facing a pallet based on whether or not a shape of the pallet included in an image is symmetrical.

### CITATION LIST

### Patent Literature

[Patent Literature 1] Japanese Unexamined Patent Application Publication No. 2021-24718
[Patent Literature 2] Japanese Unexamined Patent Application Publication No. 2020-109030

### SUMMARY OF INVENTION

### Technical Problem

In the invention disclosed in Patent Literature 1, since a position and a posture of the pallet are calculated by the length of the line segment of the BB and comparing BB data with reference data, a position and a posture of the pallet may not be estimated with high accuracy.

In the invention disclosed in Patent Literature 2, since the estimation is performed based on whether or not a shape of the pallet included in an image is symmetrical, a position and a posture of the pallet which is not facing the forklift cannot be estimated.

Therefore, in the invention disclosed in Patent Literature 1 and Patent Literature 2, a position and a posture of the pallet may not be estimated efficiently.

### Solution to Problem

A movement target specification system according to the present disclosure includes:
holding means for holding a movement target;
height acquisition means for acquiring a height of an image capturing apparatus attached to the holding means;
recognition means for recognizing positions of corners present on a front surface of the movement target in an image of the movement target captured by using the image capturing apparatus;
search means for searching for similar data similar to the image of the movement target in accordance with the acquired height of the image capturing apparatus and the recognized positions of the corners present on the front surface of the movement target;
estimation means for estimating positions of corners present on a rear surface of the movement target in accordance with the similar data that has been searched for; and
specification means for specifying a state of the movement target in accordance with the recognized positions of the corners present on the front surface of the movement target and the estimated positions of the corners present on the rear surface of the movement target.

A movement target specification apparatus according to the present disclosure includes:
holding means for holding a movement target;
height acquisition means for acquiring a height of an image capturing apparatus attached to the holding means;
recognition means for recognizing positions of corners present on a front surface of the movement target in an image of the movement target captured by using the image capturing apparatus;
search means for searching for similar data similar to the image of the movement target in accordance with the acquired height of the image capturing apparatus and the recognized positions of the corners present on the front surface of the movement target;
estimation means for estimating positions of corners present on a rear surface of the movement target in accordance with the similar data that has been searched for; and
specification means for specifying a state of the movement target in accordance with the recognized positions of the corners present on the front surface of the movement target and the estimated positions of the corners present on the rear surface of the movement target.

A target specification method according to the present disclosure includes:
capturing an image of a target by using an image capturing apparatus;
acquiring a height of the image capturing apparatus;
recognizing positions of corners present on a front surface of the target in the image of the target captured by using the image capturing apparatus;
searching for similar data similar to the image of the target in accordance with the acquired height of the image capturing apparatus and the recognized positions of the corners present on the front surface of the target:
estimating positions of corners present on a rear surface of the target in accordance with the similar data that has been searched for; and
specifying a state of the target in accordance with the recognized positions of the corners present on the front surface of the target and the estimated positions of the corners present on the rear surface of the target.

A computer readable medium according to the present disclosure is a non-transitory computer readable medium storing a program for causing an information processing apparatus to:
capture an image of a target by using an image capturing apparatus;
acquire a height of the image capturing apparatus;
recognize positions of corners present on a front surface of the target in the image of the target captured by using the image capturing apparatus;
search for similar data similar to the image of the target in accordance with the acquired height of the image capturing apparatus and the recognized positions of the corners present on the front surface of the target;
estimate positions of corners present on a rear surface of the target in accordance with the similar data that has been searched for; and
specify a state of the target in accordance with the recognized positions of the corners present on the front surface of the target and the estimated positions of the corners present on the rear surface of the target.

### Advantageous Effects of Invention

According to the present disclosure, it is possible to provide a movement target specification system capable of efficiently estimating a position and a posture of a pallet.

### BRIEF DESCRIPTION OF DRAWINGS

FIG. 1 is a schematic diagram of a movement target specification system according to an example embodiment;

FIG. 2 is a block diagram showing a configuration of the movement target specification system according to the example embodiment;

FIG. 3 is a flowchart of a target specification method according to the example embodiment;

FIG. 4 is a block diagram of a movement target specification system according to a first example embodiment;

FIG. 5 is a diagram showing a hierarchy of a dictionary data unit according to the first example embodiment;

FIG. 6 is a flowchart of a target specification method according to the first example embodiment;

FIG. 7 is a diagram showing recognition of positions of corners on the front surface, searching of dictionary data, and estimation of positions of corners on the rear surface according to the first example embodiment; and

FIG. 8 is a diagram in which a position and a posture of a movement target are obtained from the positions of the corners on the front surface and the positions of the corners on the rear surface according to the first example embodiment by solving a PnP problem.

### EXAMPLE EMBODIMENT

Example embodiments of the present invention will be described hereinafter with reference to the drawings. However, the disclosure according to the claims is not limited to the following example embodiments. Further, all the components described in the example embodiments are not necessarily essential as means for solving the problem. In order to clarify the description, the following descriptions and the drawings are partially omitted and simplified as appropriate. The same elements are denoted by the same reference symbols throughout the drawings, and redundant descriptions are omitted as necessary.

### Description of a Movement Target Specification System According to an Example Embodiment

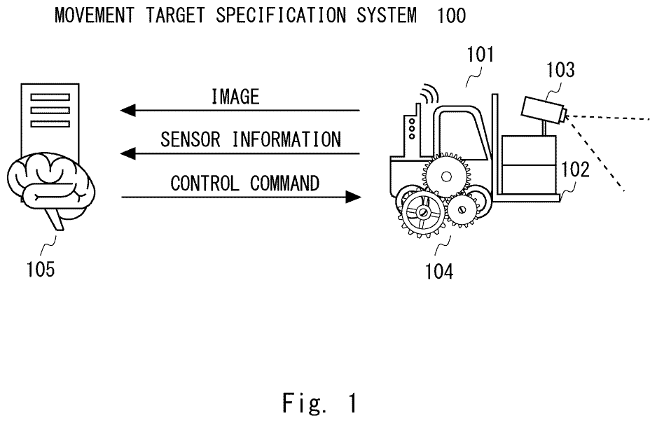

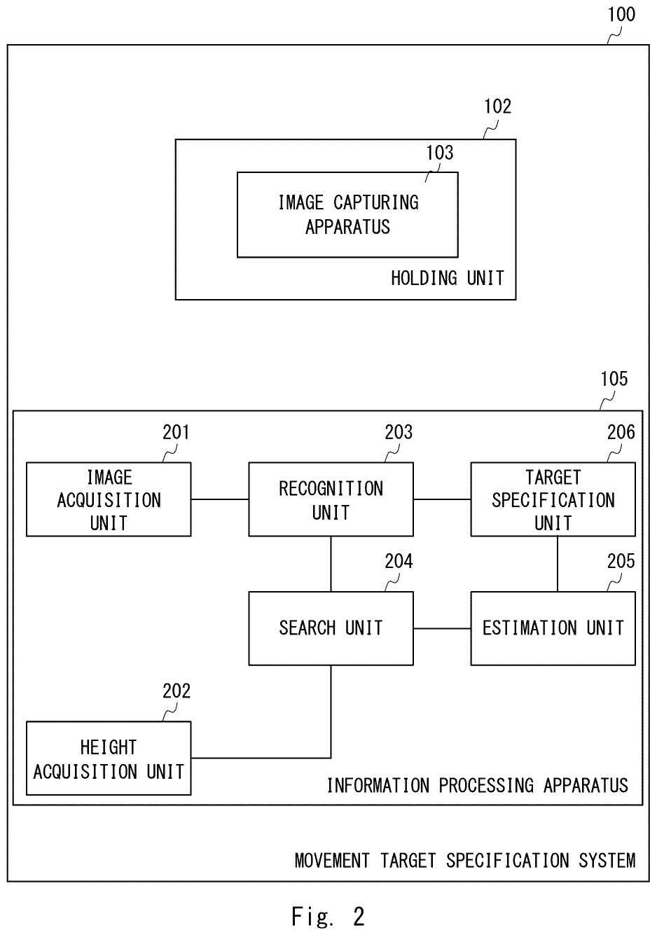

FIG. 1 is a schematic diagram of a movement target specification system according to an example embodiment. FIG. 2 is a block diagram showing a configuration of the movement target specification system according to the example embodiment. The movement target specification system according to the example embodiment will be described with reference to FIGS. 1 and 2.

As shown in FIG. 1, a movement target specification system 100 according to the example embodiment includes a mobile body 101, a holding unit 102, an image capturing apparatus 103, a sensor 104, and an information processing apparatus 105.

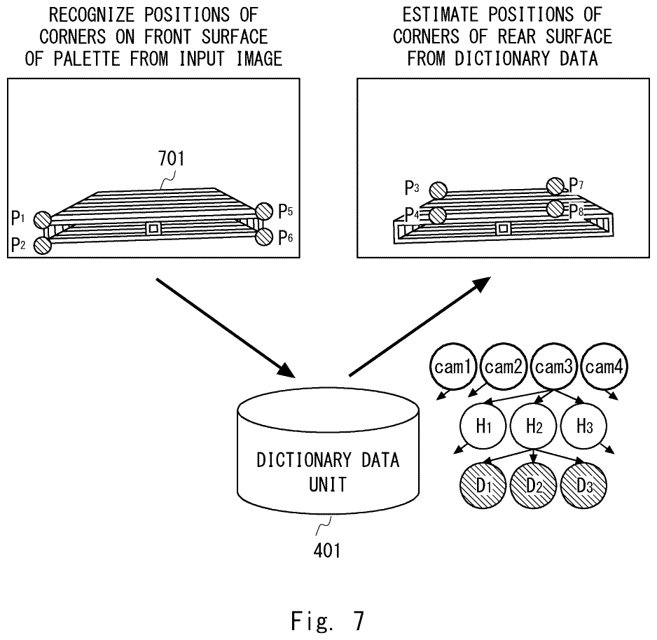

The mobile body 101 is, for example, a forklift. The mobile body 101 can transport and move a movement target (i.e., an object to be moved) 701 (see FIG. 7) having a predetermined shape by using the holding unit 102. The mobile body 101 itself does not need to move. The mobile body 101 only needs to be able to change a height of the movement target 701 by using the holding unit 102. The movement target 701 is, for example, a pallet, and has a fixed size. The movement target 701 is a load carrying platform for carrying a load. Further, the front surface of the movement target 701 has a rectangular parallelepiped shape. That is, there are four positions of corners present on the front surface of the movement target 701. Similarly, there are four positions of corners present on the rear surface of the movement target 701. The movement target 701 has insertion holes in the corners on the front surface thereof, and is lifted by inserting the holding unit 102 into the holes.

The holding unit 102 is, for example, a fork attached to a forklift. The holding unit 102 has an L-shape in a side view, and holds the movement target 701 by inserting the bottom part thereof into the movement target 701. The holding unit 102 can be moved up and down. Therefore, the height of the holding unit 102 can be changed.

The image capturing apparatus 103 is, for example, an RGB-D camera. The RGB-D camera is a camera that outputs depth data and color data. Further, for example, an RGB camera and a depth sensor may be used as the image capturing apparatus 103. A plurality of the image capturing apparatuses 103 may be used. The image capturing apparatus 103 is attached to the holding unit 102 and captures an image of the surroundings of the image capturing apparatus 103 and the movement target 701. The image capturing apparatus 103 may be configured so that it performs driving assistance or automated driving by capturing an image of the surroundings of the image capturing apparatus 103. Further, by capturing an image of the movement target 701, the image capturing apparatus 103 can specify a position and a posture of the movement target 701 as described later.

The sensors 104 are various types of sensors that sense a state of the mobile body 101 or the holding unit 102. Since the holding unit 102 is attached to the mobile body 101, the sensor 104 acquires, in particular, the height of the holding unit 102 relative to the mobile body 101. The sensor 104 may acquire the height of the holding unit 102 based on information about the operation of the lift cylinder performed by the mobile body 101. Further, the sensor 104 may measure the height of the holding unit 102 from the ground. The sensor 104 may measure the height from the ground by attaching a LiDAR, a laser sensor, a radar sensor, or a ToF sensor, which is a distance measuring sensor, to the holding unit 102. Since the image capturing apparatus 103 is attached to the holding unit 102, acquiring the height of the holding unit 102 is equivalent to acquiring the height of the image capturing apparatus 103. By acquiring the height of the holding unit 102 at the time of the capturing of an image of the movement target 701 by using the image capturing apparatus 103, the height of the image capturing apparatus 103 at the time of the capturing of the image of the movement target 701 can be acquired. For driving assistance or automated driving performed by the mobile body 101, the sensor 104 may sense the position and the speed of the mobile body 101, the distance from the movement target 701 to the holding unit 102, and the like.

The information processing apparatus 105 processes data collected from various types of apparatuses and sensors attached to the mobile body 101. The information processing apparatus 105 is network-connected to the mobile body 101 by, for example, Wi-Fi (registered trademark) or Bluetooth (registered trademark). The information processing apparatus includes at least one processor that executes instructions and at least one memory that stores the instructions. For example, the information processing apparatus 105 acquires an image from the image capturing apparatus 103. Further, the information processing apparatus 105 acquires sensor information from the sensor 104. Further, the information processing apparatus 105 issues a control command to the mobile body 101, controls the mobile body 101 to perform driving assistance or automated driving. The information processing apparatus 105 may include, for example, a machine learning device. Further, some or all of the functions of the information processing apparatus 105 may be distributed in the cloud. Further, the information processing apparatus 105 may be composed of one apparatus or a plurality of apparatuses. In this example, it is shown that the information processing apparatus 105 remotely controls the mobile body 101. However, the information processing apparatus 105 may be installed in the mobile body 101 and the mobile body 101 may operate independently. In this case, they can be regarded as one movement target specification apparatus.

If a position and a posture of the movement target 701 can be specified, the operations performed by an operator of the mobile body 101 can be assisted. Further, it is possible to contribute to the realization of automated driving of the mobile body 101.

The processes performed by the information processing apparatus 105 according to the example embodiment will be described with reference to FIG. 2. As shown in FIG. 2, the information processing apparatus 105 includes an image acquisition unit 201, a height acquisition unit 202, a recognition unit 203, a search unit 204, an estimation unit 205, and a target specification unit 206.

The image acquisition unit 201 acquires an image from the image capturing apparatus 103 attached to the holding unit 102. The image from the image capturing apparatus 103 may be a normal RGB image which does not include depth direction information. Further, the image includes the movement target 701.

The height acquisition unit 202 acquires the height of the holding unit 102 at the time of the capturing of an image. The height of the holding unit 102 at the time of the capturing of an image is the height of the image capturing apparatus 103 at the time of the capturing of an image.

The recognition unit 203 recognizes the positions of the corners present on the front surface of the movement target 701 from the captured image. As described above, it recognizes the positions of the four corners on the front surface of the movement target 701 which has a rectangular parallelepiped shape. Note that “recognizing” the positions of the four corners means specifying the positions where the four corners are present. As a recognition method, a known method can be used. For example, the front surface of a pallet may be cut out by using a result of the recognition of a pallet hole, and positions Pk of the corners on the front surface of the pallet may be recognized by using edge detection. The edge detection is a method for recognizing a part of an image where changes are discontinuous in accordance with the amount of change in the feature in the image. Further, feature point information of the positions of the corners may be machine learned in advance, and the image of the movement target 701 may be input to recognize the positions Pk of the corners on the front surface by using feature point matching. The image of the movement target may be input to a machine learning device that has learned the images of a plurality of movement targets to recognize the positions of the corners present on the front surface of the movement target. Further, the image of the movement target 701 may be input to recognize only the positions PK of the corners on the front surface by using a 6D Pose estimation technique using a convolutional neural network. The 6D Pose is information indicating the position and the posture of the target by a three-axis rotation vector and a three-axis translation vector.

The search unit 204 is a part having a function of searching for similar data similar to an image of the movement target 701 in accordance with the height of the holding unit 102 at the time of the capturing of the image of the movement target 701 and the recognized positions of the corners on the front surface of the movement target 701. The similar data is an image of the movement target 701 stored in advance. The search unit 204 stores the similar data in which the images of the movement target 701 have been captured under a plurality of conditions. The search unit 204 searches for the similar data based on the height of the holding unit 102 at the time of the capturing of the image of the movement target 701. The search unit 204 is a trained machine learning device that stores a plurality of combinations of the positions of the corners on the front surface of the movement target 701 in the captured image and the positions of the corners present on the rear surface of the movement target 701 in the captured image as a training data set and have learned them.

The estimation unit 205 is a part having a function of estimating the positions of the corners present on the rear surface of the movement target in accordance with similar data that has been searched for. That is, if the positions of the corners present on the front surface of the movement target 701 are input, the estimation unit 205 estimates the positions of the corners present on the rear surface of the movement target 701 by, for example, a trained machine learning device that outputs the positions of the corners present on the rear surface of the movement target 701.

The target specification unit 206 is a part having a function of specifying a state of the movement target 701 in accordance with the recognized positions of the corners present on the front surface of the movement target 701 and the estimated positions of the corners present on the rear surface of the movement target 701. The target specification unit 206, for example, specifies a three-dimensional posture and position (6D Pose) of the movement target 701 by solving a PnP problem based on the recognized positions of the corners present on the front surface of the movement target 701 and the estimated positions of the corners present on the rear surface of the movement target 701. In order to solve the PnP problem, the internal parameters of the image capturing apparatus 103 are known. Further, the size of the movement target 701 is also known. The PnP problem can be solved by using a known method.

In the description of the example embodiment, the holding unit 102, the image acquisition unit 201, the height acquisition unit 202, the recognition unit 203, the search unit 204, the estimation unit 205, and the target specification unit 206 may be read as holding means, acquisition means, recognition means, search means, estimation means, and target specification means.

In a method for solving a PnP problem to obtain the 6D Pose from nine points of the positions of the corners on the front surface, the positions of the corners on the rear surface, and the center position, there is a possibility that the 6D Pose cannot be estimated accurately if the rear part of the pallet is not captured in the image due to a large load or if the learning has not been sufficiently performed. In a case where the rear part of the movement target is not included in the image or in a case where the learning of the movement target has not been sufficiently performed, by using the movement target specification system according to the present disclosure, the position and the posture of the target can be estimated more accurately than in the technology of estimating the 6D Pose of a target based on a convolutional neural network. Therefore, it is possible to assist an operator of the mobile body 101. Further, it is possible to contribute to the realization of automated driving of the mobile body 101.

If a position and a posture of the pallet are estimated only from BB data, positions of the corners need to be estimated by some method after the BB data is acquired. Therefore, the calculation may not be stable. However, since the movement target specification system according to the example embodiment can accurately specify the positions of the corners present on the rear surface in a short time, the position and the posture can be stably specified.

### Description of a Target Specification Method According to the Example Embodiment

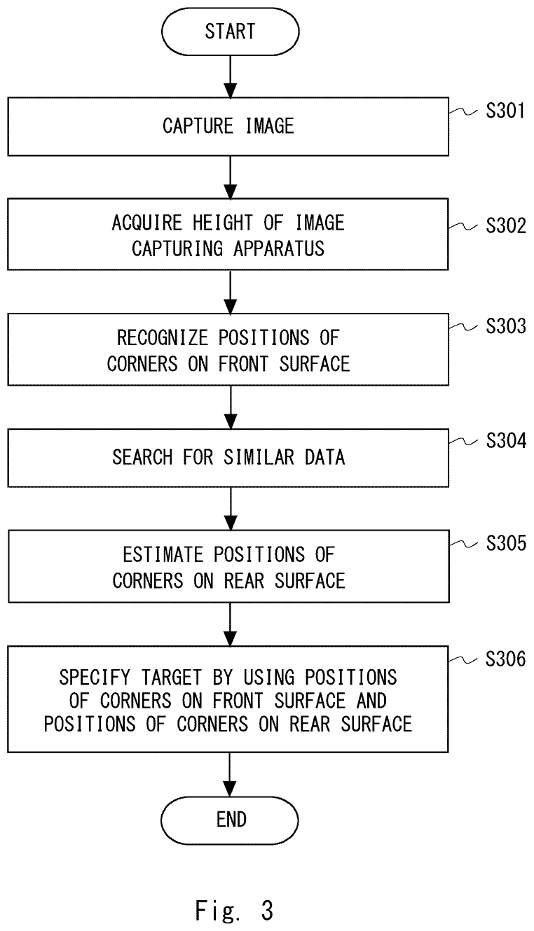

FIG. 3 is a flowchart of a target specification method according to the example embodiment. The target specification method according to the example embodiment will be described with reference to FIG. 3.

As shown in FIG. 3, an image is first captured (Step S301). An image of a target is captured by using the image capturing apparatus 103. Next, the height of the image capturing apparatus is acquired (Step S302). The information processing apparatus 105 acquires the height of the image capturing apparatus 103 at the time of the capturing of the image of the target. Next, the positions of the corners on the front surface are recognized (Step S303). The information processing apparatus 105 recognizes the positions of the corners present on the front surface of the target in the captured image. Next, similar data is searched for (Step S304). The information processing apparatus 105 searches for similar data similar to the image of the target in accordance with the height of the image capturing apparatus at the time of the capturing of the image of the target and the recognized positions of the corners present on the front surface of the target.

Next, the positions of the corners on the rear surface are estimated (Step S305). The information processing apparatus 105 estimates the positions of the corners present on the rear surface of the target in accordance with the similar data that has been searched for. Next, the target is specified by using the positions of the corners on the front surface and the positions of the corners on the rear surface (Step S306). The information processing apparatus 105 specifies a state of the target in accordance with the recognized positions of the corners present on the front surface of the target and the estimated positions of the corners present on the rear surface of the target.

By using such a target specification method, the position and the posture of the target can be obtained more efficiently than in related art and more accurately than by a method for calculating the 6D Pose from the positions of the corners present on the front surface.

### Description of a Movement Target Specification System According to a First Example Embodiment

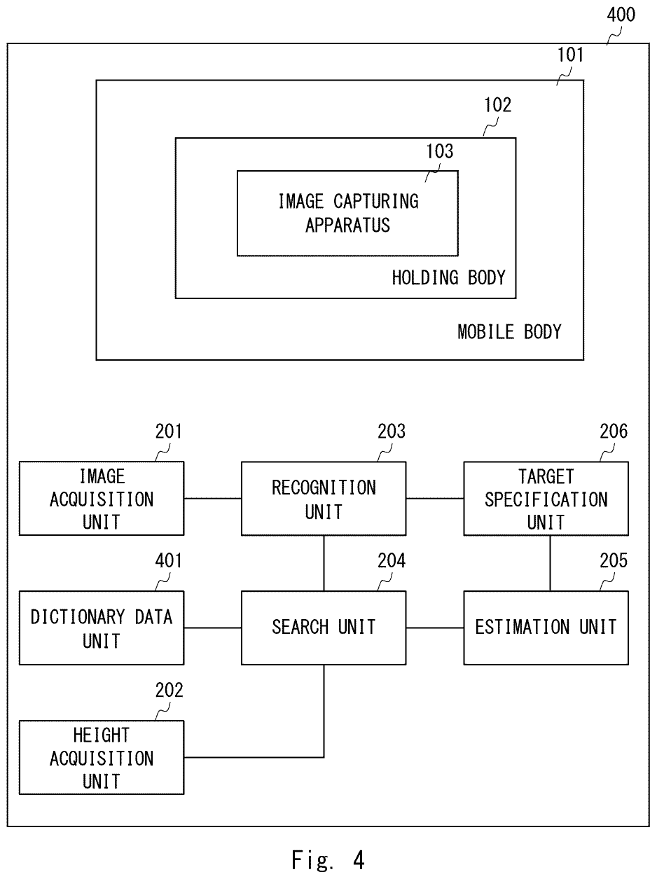

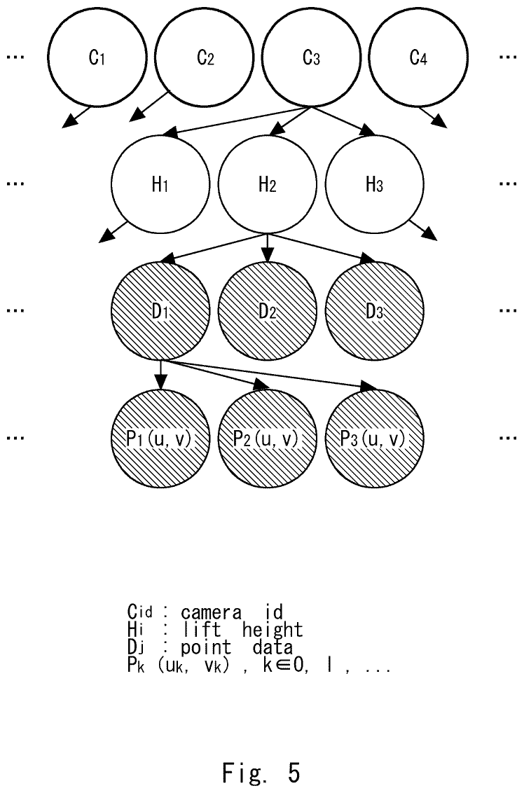

A first example embodiment shows an example of the example embodiment and includes examples of configurations and operations that are not essential. FIG. 4 is a block diagram of a movement target specification system according to the first example embodiment. FIG. 5 is a diagram showing a hierarchy of a dictionary data unit according to the first example embodiment. The movement target specification system according to the first example embodiment will be described with reference to FIGS. 4 and 5.

As shown in FIG. 4, a movement target specification system 400 according to the first example embodiment is different from the movement target specification system 100 according to the example embodiment in that it further includes the mobile body 101 and a dictionary data unit 401.

The dictionary data unit 401 registers a plurality of similar data. The similar data are captured images of the movement target 701. The dictionary data unit 401 registers a plurality of pieces of similar data obtained by capturing images of the movement target 701 from various heights and angles.

As shown in FIG. 5, the dictionary data unit 401 has a hierarchical structure. The dictionary data unit 401 stores similar data obtained by capturing the movement target 701 at heights Hᵢ(i=1, 2, . . . ) of the holding unit 102 respectively for a plurality of cameras C_{id}(id=1, 2, . . . ) attached to the holding unit 102. As the similar data, a point cloud data Dᵢ(i=1, 2, . . . ) having various positions P₁(u, v), P₂(u, v), P₅(u, v), and P₆(u, v) of the corners present on the front surface and various positions P₃(u,v), P₄(u, v), P₇(u,v), and P₈(u,v) of the corners present on the rear surface is registered.

The search unit 204 specifies, from the dictionary data unit 401, similar data in which the camera id is the same as that of the camera that has captured the image of the movement target 701, the degree of error in the height of the holding unit 102 at the time of the capturing of the image of the movement target 701 is small, and the degree of error in the positions of the corners present on the front surface of the movement target 701 is small. By doing so, the search unit 204 searches for similar data similar to the image of the movement target 701. Similar data which the search unit 204 searches for is preferably similar data in which the degree of error in the height of the holding unit 102 at the time of the capturing of the image of the movement target 701 is the smallest, and the degree of error in the positions of the corners present on the front surface of the movement target 701 is the smallest.

If similar data is found and it completely matches the image of the movement target, the positions of the corners present on the rear surface in the similar data are used. However, there are few similar data that completely match the image of the movement target, and in this case, the positions of the corners present on the rear surface are estimated by the following calculation method.

First, a conversion formula λₖ from a reference point P₁ to a virtual point Pₖ is calculated. λₖ is expressed by the following equation.

$${λ}_{k} = \frac{{D}_{m} ( {P}_{k} )}{{D}_{m} ( {P}_{1} )} ( k ∉ 1 ) \qquad [ Expression 1 ]$$

In this equation, Dₘ is point cloud data in which the degree of error in the positions of the corners present on the front surface is the smallest.

The virtual point Pₖ is then calculated from the reference point P₁ by using the above conversion formula λₖ.

$${P}_{k} = {λ}_{k} {P}_{1} ( k ∉ 1 ) \qquad [ Expression 2 ]$$

As described above, the positions of the corners present on the rear surface, which is the virtual points, are estimated from the positions of the corners present on the front surface. Further, the 6D Pose can be estimated with high accuracy by solving a PnP problem using the positions of the corners present on the front surface and the positions of the corners present on the rear surface.

In this way, the position and the posture of the pallet can be estimated efficiently.

### Description of a Target Specification Method According to the First Example Embodiment

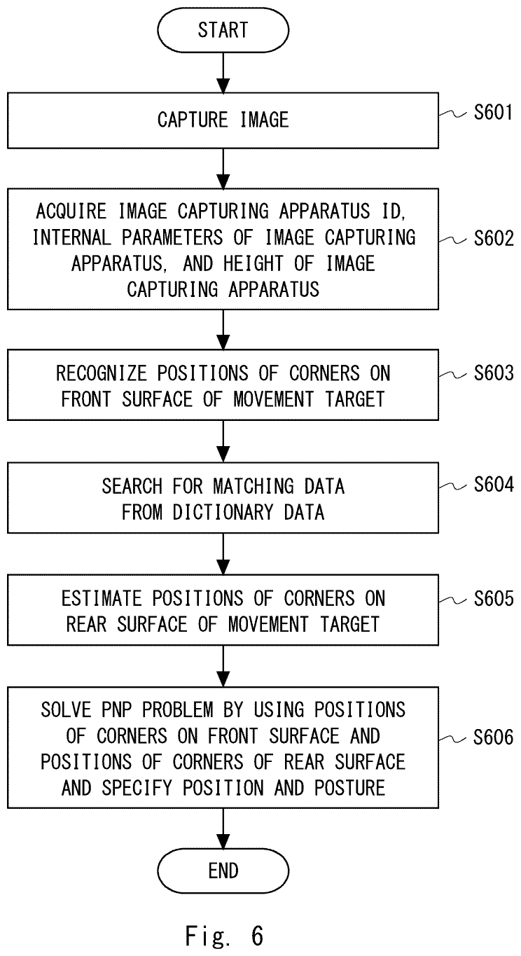

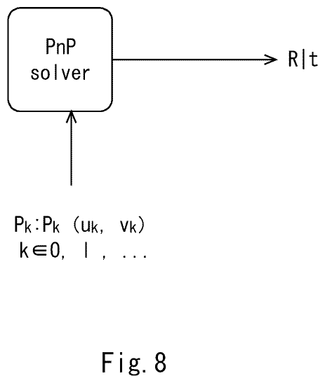

FIG. 6 is a flowchart of a target specification method according to the first example embodiment. FIG. 7 is a diagram showing recognition of positions of corners on the front surface, searching of dictionary data, and estimation of positions of corners on the rear surface according to the first example embodiment. FIG. 8 is a diagram in which a position and a posture of a movement target are obtained from the positions of the corners on the front surface and the positions of the corners on the rear surface according to the first example embodiment by solving a PnP problem. The target specification method according to the first example embodiment will be described with reference to FIGS. 6 to 8.

As shown in FIG. 6, an image is first acquired (Step S601). The image capturing apparatus 103 captures an image of the movement target 701. Next, the information processing apparatus 105 acquires an image capturing apparatus Identification (ID), internal parameters of the image capturing apparatus, and the height of the image capturing apparatus (Step S602). The internal parameters differ for each image capturing apparatus 103. The internal parameters of the image capturing apparatus 103 are required to solve a PnP problem. Therefore, the information processing apparatus 105 needs to acquire the image capturing apparatus ID and the internal parameters of the image capturing apparatus.

Next, the information processing apparatus 105 recognizes the positions of the corners on the front surface of the movement target (Step S603). Next, the information processing apparatus 105 searches for matching data from the dictionary data unit 401 (Step S604). Next, the information processing apparatus 105 estimates the positions of the corners on the rear surface of the movement target 701 (Step S605). These three processes will be described with reference to FIG. 7.

As shown in the upper left of FIG. 7, four positions P₁, P₂, P₅, and P₆ of the corners present on the front surface of the movement target 701 are recognized by using machine learning or the like. Next, as shown in the lower part of FIG. 7, similar data is searched for from the dictionary data unit 401.

Similar data in which the image capturing apparatuses 103 are matched with each other, the degree of error in the height of the image capturing apparatus is the smallest, and the positions of the corners on the front surface are closest to those in the captured image is found, and four positions P₃, P₄, P₇, and P₈ of the corners present on the rear surface are estimated as shown in the upper left of FIG. 7. As described above, an estimation method is a method for calculating the conversion formula λₖ from the reference point P₁ to the virtual point Pₖ which is the position of the corner present on the rear surface, and then calculating the virtual point Pₖ by converting it from the reference point P₁.

Lastly, the information processing apparatus 105 solves a PnP problem by using the positions of the corners on the front surface and the positions of the corners on the rear surface and specifies the position and the posture (Step S606). As shown in FIG. 8, the information processing apparatus 105 solves a PnP problem by using Pₖ(uₖ,vₖ) (k=0, 1 . . . ) which is the position of the corner of the movement target 701. Note that P₀(u₀, v₀) is the center point of the movement target 701. After a PnP problem is solved, R|t of the 6D Pose, which is the three-dimensional posture of the movement target 701, is obtained.

Since the 6D Pose can be estimated, it is possible to calculate, for example, the turning radius and the number of turns which enable the mobile body 101 to face the movement target 701.

It is also possible to estimate the 6D pose of a pallet geometrically by restoring the front surface of the pallet in three dimensions using a Depth sensor without solving a PnP problem. However, in this case, a high-accurate Depth sensor is required, and it is essential to acquire stable distance information by LiDAR or the like. Therefore, it is difficult to perform an estimation with high accuracy by using an inexpensive RGB-D camera. As described above, by solving a PnP problem using the positions of the corners on the front surface and the positions of the corners on the rear surface and specifying a position and a posture of the movement target, the position and the posture of the movement target can be estimated by using an inexpensive RGB-D camera.

As disclosed in the example embodiment and the first example embodiment, a position and a posture of the movement target can be estimated with high accuracy by estimating the positions of the corners present on the rear surface of the movement target in accordance with the positions of the corners present on the front surface of the movement target.

Further, some or all of the above-described processes performed by the information processing apparatus 105 can be implemented as a computer program. The above program can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g., magneto-optical disks), CD-ROM (Read Only Memory), CD-R, CD-R/W, and semiconductor memories (such as mask ROM, PROM (Programmable ROM), EPROM (Erasable PROM), flash ROM, RAM (Random Access Memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires and optical fibers) or a wireless communication line.

Note that the present invention is not limited to the above-described example embodiments and may be changed as appropriate without departing from the scope and spirit of the present invention.

The whole or part of the example embodiments disclosed above can be described as, but not limited to, the following supplementary notes.

### (Supplementary Note 1)

A movement target specification system comprising:
holding means for holding a movement target;
height acquisition means for acquiring a height of an image capturing apparatus attached to the holding means;
recognition means for recognizing positions of corners present on a front surface of the movement target in an image of the movement target captured by using the image capturing apparatus;
search means for searching for similar data similar to the image of the movement target in accordance with the acquired height of the image capturing apparatus and the recognized positions of the corners present on the front surface of the movement target;
estimation means for estimating positions of corners present on a rear surface of the movement target in accordance with the similar data that has been searched for; and
specification means for specifying a state of the movement target in accordance with the recognized positions of the corners present on the front surface of the movement target and the estimated positions of the corners present on the rear surface of the movement target.

### (Supplementary Note 2)

The movement target specification system according to supplementary note 1, wherein the recognition means recognizes the positions of the corners present on the front surface of the movement target in accordance with an amount of change in a feature in the image. (Supplementary Note 3)

The movement target specification system according to supplementary note 1, wherein the recognition means inputs the image of the movement target to a machine learning device that has learned images of a plurality of the movement targets and recognizes the positions of the corners present on the front surface of the movement target.

### (Supplementary Note 4)

The movement target specification system according to supplementary note 1, wherein
a plurality of pieces of the similar data are registered in dictionary data, and
the search means searches for the similar data similar to the image of the movement target by specifying, from the dictionary data, similar data in which the acquired heights of the image capturing apparatuses are similar to each other and a degree of error in the positions of the corners present on the front surface of the movement target is small.

### (Supplementary Note 5)

The movement target specification system according to supplementary note 1, wherein the state of the movement target is a three-dimensional posture and position of the movement target.

### (Supplementary Note 6)

The movement target specification system according to supplementary note 1, wherein
the movement target has a rectangular parallelepiped shape,
the number of the positions of the corners present on the front surface of the movement target is four, and
the number of the positions of the corners present on the rear surface of the movement target is four.

### (Supplementary Note 7)

The movement target specification system according to supplementary note 1, wherein the holding means is a fork, the movement target is a pallet having a fixed size, and the image capturing apparatus is an RGB-D camera.

### (Supplementary Note 8)

The movement target specification system according to supplementary note 5, the specification means specifies a three-dimensional posture and position of the movement target by solving a PnP problem using the recognized positions of the corners present on the front surface of the movement target and the estimated positions of the corners present on the rear surface of the movement target.

### (Supplementary Note 9)

A movement target specification apparatus comprising:
holding means for holding a movement target;
height acquisition means for acquiring a height of an image capturing apparatus attached to the holding means;
recognition means for recognizing positions of corners present on a front surface of the movement target in an image of the movement target captured by using the image capturing apparatus;
search means for searching for similar data similar to the image of the movement target in accordance with the acquired height of the image capturing apparatus and the recognized positions of the corners present on the front surface of the movement target;
estimation means for estimating positions of corners present on a rear surface of the movement target in accordance with the similar data that has been searched for; and
specification means for specifying a state of the movement target in accordance with the recognized positions of the corners present on the front surface of the movement target and the estimated positions of the corners present on the rear surface of the movement target.

### (Supplementary Note 10)

The movement target specification apparatus according to supplementary note 9, wherein the recognition means recognizes the positions of the corners on the front surface of the movement target in accordance with an amount of change in a feature in the image.

### (Supplementary Note 11)

The movement target specification apparatus according to supplementary note 9, wherein the recognition means inputs the image of the movement target to a machine learning device that has learned images of a plurality of the movement targets and recognizes the positions of the corners present on the front surface of the movement target.

### (Supplementary Note 12)

The movement target specification apparatus according to supplementary note 9, wherein
a plurality of pieces of the similar data are registered in dictionary data, and
the search means searches for the similar data similar to the image of the movement target by specifying, from the dictionary data, similar data in which the acquired heights of the image capturing apparatuses are similar to each other and a degree of error in the positions of the corners present on the front surface of the movement target is small.

### (Supplementary Note 13)

The movement target specification apparatus according to supplementary note 9, wherein the state of the movement target is a three-dimensional posture and position of the movement target.

### (Supplementary Note 14)

The movement target specification apparatus according to supplementary note 9, wherein
the movement target has a rectangular parallelepiped shape,
the number of the positions of the corners present on the front surface of the movement target is four, and
the number of the positions of the corners present on the rear surface of the movement target is four.

### (Supplementary Note 15)

The movement target specification apparatus according to supplementary note 9, wherein the holding means is a fork, the movement target is a pallet having a fixed size, and the image capturing apparatus is an RGB-D camera.

### (Supplementary Note 16)

The movement target specification apparatus according to supplementary note 13, the specification means specifies a three-dimensional posture and position of the movement target by solving a PnP problem using the recognized positions of the corners present on the front surface of the movement target and the estimated positions of the corners present on the rear surface of the movement target.

### (Supplementary Note 17)

A target specification method comprising:
capturing an image of a target by using an image capturing apparatus;
acquiring a height of the image capturing apparatus;
recognizing positions of corners present on a front surface of the target in the image of the target captured by using the image capturing apparatus;
searching for similar data similar to the image of the target in accordance with the acquired height of the image capturing apparatus and the recognized positions of the corners present on the front surface of the target;
estimating positions of corners present on a rear surface of the target in accordance with the similar data that has been searched for; and
specifying a state of the target in accordance with the recognized positions of the corners present on the front surface of the target and the estimated positions of the corners present on the rear surface of the target.

### (Supplementary Note 18)

The target specification method according to supplementary note 17, wherein in the recognition, the positions of the corners present on the front surface of the target are recognized in accordance with an amount of change in a feature in the image.

### (Supplementary Note 19)

The target specification method according to supplementary note 17, wherein in the recognition, the image of the target is input to a machine learning device that has learned images of a plurality of the targets, and the positions of the corners present on the front surface of the target are recognized.

### (Supplementary Note 20)

The target specification method according to supplementary note 17, wherein
a plurality of pieces of the similar data are registered in dictionary data, and
in the searching, the similar data similar to the image of the target is searched for by specifying, from the dictionary data, similar data in which the acquired heights of the image capturing apparatuses are similar to each other and a degree of error in the positions of the corners present on the front surface of the target is small.

### (Supplementary Note 21)

The target specification method according to supplementary note 17, wherein the state of the target is a three-dimensional posture and position of the target.

### (Supplementary Note 22)

The target specification method according to supplementary note 17, wherein
the target has a rectangular parallelepiped shape,
the number of the positions of the corners present on the front surface of the target is four, and
the number of the positions of the corners present on the rear surface of the target is four.

### (Supplementary Note 23)

The target specification method according to supplementary note 17, wherein the target is a pallet having a fixed size, and the image capturing apparatus is an RGB-D camera.

### (Supplementary Note 24)

The target specification method according to supplementary note 21, in the specification, a three-dimensional posture and position of the target is specified by solving a PnP problem using the recognized positions of the corners present on the front surface of the target and the estimated positions of the corners present on the rear surface of the target.

### (Supplementary Note 25)

A non-transitory computer readable medium storing a program for causing an information processing apparatus to:
capture an image of a target by using an image capturing apparatus;
acquire a height of the image capturing apparatus;
recognize positions of corners present on a front surface of the target in the image of the target captured by using the image capturing apparatus;
search for similar data similar to the image of the target in accordance with the acquired height of the image capturing apparatus and the recognized positions of the corners present on the front surface of the target;
estimate positions of corners present on a rear surface of the target in accordance with the similar data that has been searched for; and
specify a state of the target in accordance with the recognized positions of the corners present on the front surface of the target and the estimated positions of the corners present on the rear surface of the target.

### (Supplementary Note 26)

The non-transitory computer readable medium storing a program according to supplementary note 25, wherein in the recognition, the positions of the corners present on the front surface of the target are recognized in accordance with an amount of change in a feature in the image.

### (Supplementary Note 27)

The non-transitory computer readable medium storing a program according to supplementary note 25, wherein in the recognition, the image of the target is input to a machine learning device that has learned images of a plurality of the targets, and the positions of the corners present on the front surface of the target are recognized.

### (Supplementary Note 28)

The non-transitory computer readable medium storing a program according to supplementary note 25, wherein
a plurality of pieces of the similar data are registered in dictionary data, and
in the searching, the similar data similar to the image of the target is searched for by specifying, from the dictionary data, similar data in which the acquired heights of the image capturing apparatuses are similar to each other and a degree of error in the positions of the corners present on the front surface of the target is small.

### (Supplementary Note 29)

The non-transitory computer readable medium storing a program according to supplementary note 25, wherein the state of the target is a three-dimensional posture and position of the target.

### (Supplementary Note 30)

The non-transitory computer readable medium storing a program according to supplementary note 25, wherein
the target has a rectangular parallelepiped shape,
the number of the positions of the corners present on the front surface of the target is four, and
the number of the positions of the corners present on the rear surface of the target is four.

### (Supplementary Note 31)

The non-transitory computer readable medium storing a program according to supplementary note 25, wherein the target is a pallet having a fixed size, and the image capturing apparatus is an RGB-D camera.

### (Supplementary Note 32)

The non-transitory computer readable medium storing a program according to supplementary note 29, in the specification, a three-dimensional posture and position of the target is specified by solving a PnP problem using the recognized positions of the corners present on the front surface of the target and the estimated positions of the corners present on the rear surface of the target.

### REFERENCE SIGNS LIST

100 MOVEMENT TARGET SPECIFICATION SYSTEM, 101 MOBILE BODY, 102 HOLDING UNIT, 103 IMAGE CAPTURING APPARATUS, 104 SENSOR, 105 INFORMATION PROCESSING APPARATUS, 201 IMAGE ACQUISITION UNIT, 202 HEIGHT ACQUISITION UNIT, 203 RECOGNITION UNIT, 204 SEARCH UNIT, 205 ESTIMATION UNIT, 206 TARGET SPECIFICATION UNIT, 400 MOVEMENT TARGET SPECIFICATION SYSTEM, 401 DICTIONARY DATA UNIT, 701 MOVEMENT TARGET

What is claimed is:

1. A movement target specification system comprising:
at least one memory configured to store instructions; and
at least one processor configured to execute the instructions to:
hold a movement target by a holding unit;
acquire a height of an image capturing apparatus attached to the holding unit;
recognize positions of corners present on a front surface of the movement target in an image of the movement target captured by using the image capturing apparatus;
search for similar data similar to the image of the movement target in accordance with the acquired height of the image capturing apparatus and the recognized positions of the corners present on the front surface of the movement target;
estimate positions of corners present on a rear surface of the movement target in accordance with the similar data that has been searched for; and
specify a state of the movement target in accordance with the recognized positions of the corners present on the front surface of the movement target and the estimated positions of the corners present on the rear surface of the movement target.

2. The movement target specification system according to claim 1, wherein in the recognition, the positions of the corners present on the front surface of the movement target are recognized in accordance with an amount of change in a feature in the image.

3. The movement target specification system according to claim 1, wherein in the recognition, the image of the movement target is input to a machine learning device that has learned images of a plurality of the movement targets and the positions of the corners present on the front surface of the movement target are recognized.

4. The movement target specification system according to claim 1, wherein
a plurality of pieces of the similar data are registered in dictionary data, and
in the searching, for the similar data similar to the image of the movement target is searched for by specifying, from the dictionary data, similar data in which the acquired heights of the image capturing apparatuses are similar to each other and a degree of error in the positions of the corners present on the front surface of the movement target is small.

5. The movement target specification system according to claim 1, wherein the state of the movement target is a three-dimensional posture and position of the movement target.

6. The movement target specification system according to claim 1, wherein
the movement target has a rectangular parallelepiped shape,
the number of the positions of the corners present on the front surface of the movement target is four, and
the number of the positions of the corners present on the rear surface of the movement target is four.

7. The movement target specification system according to claim 1, wherein the holding unit is a fork, the movement target is a pallet having a fixed size, and the image capturing apparatus is an RGB-D camera.

8. A movement target specification apparatus comprising:
a memory configured to store instructions; and
a processor configured to execute the instructions to:
hold a movement target by a holding unit;
acquire a height of an image capturing apparatus attached to the holding unit;
recognize positions of corners present on a front surface of the movement target in an image of the movement target captured by using the image capturing apparatus;
search for similar data similar to the image of the movement target in accordance with the acquired height of the image capturing apparatus and the recognized positions of the corners present on the front surface of the movement target;
estimate positions of corners present on a rear surface of the movement target in accordance with the similar data that has been searched for; and
specify a state of the movement target in accordance with the recognized positions of the corners present on the front surface of the movement target and the estimated positions of the corners present on the rear surface of the movement target.

9. The movement target specification apparatus according to claim 8, wherein in the recognition the positions of the corners present on the front surface of the movement target are recognized in accordance with an amount of change in a feature in the image.

10. The movement target specification apparatus according to claim 8, wherein the image of the movement target is input to a machine learning device that has learned images of a plurality of the movement targets and the positions of the corners present on the front surface of the movement target are recognized.

11. The movement target specification apparatus according to claim 8, wherein
a plurality of pieces of the similar data are registered in dictionary data, and
in the searching, the similar data similar to the image of the movement target is searched for by specifying, from the dictionary data, similar data in which the acquired heights of the image capturing apparatuses are similar to each other and a degree of error in the positions of the corners present on the front surface of the movement target is small.

12. The movement target specification apparatus according to claim 8, wherein the state of the movement target is a three-dimensional posture and position of the movement target.

13. The movement target specification apparatus according to claim 8, wherein
the movement target has a rectangular parallelepiped shape,
the number of the positions of the corners present on the front surface of the movement target is four, and
the number of the positions of the corners present on the rear surface of the movement target is four.

14. The movement target specification apparatus according to claim 8, wherein the holding unit is a fork, the movement target is a pallet having a fixed size, and the image capturing apparatus is an RGB-D camera.

15. A target specification method comprising:
capturing an image of a target by using an image capturing apparatus;
acquiring a height of the image capturing apparatus;
recognizing positions of corners present on a front surface of the target in the image of the target captured by using the image capturing apparatus;
searching for similar data similar to the image of the target in accordance with the acquired height of the image capturing apparatus and the recognized positions of the corners present on the front surface of the target;
estimating positions of corners present on a rear surface of the target in accordance with the similar data that has been searched for; and
specifying a state of the target in accordance with the recognized positions of the corners present on the front surface of the target and the estimated positions of the corners present on the rear surface of the target.

16. The target specification method according to claim 15, wherein in the recognition, the positions of the corners present on the front surface of the target are recognized in accordance with an amount of change in a feature in the image.

17. The target specification method according to claim 15, wherein in the recognition, the image of the target is input to a machine learning device that has learned images of a plurality of the targets, and the positions of the corners present on the front surface of the target are recognized.

18. The target specification method according to claim 15, wherein
a plurality of pieces of the similar data are registered in dictionary data, and
in the searching, the similar data similar to the image of the target is searched for by specifying, from the dictionary data, similar data in which the acquired heights of the image capturing apparatuses are similar to each other and a degree of error in the positions of the corners present on the front surface of the target is small.

19. The target specification method according to claim 17, wherein the state of the target is a three-dimensional posture and position of the target.

20. A non-transitory computer readable medium storing a program for causing an information processing apparatus to execute the target specification method according to claim 17.
